(19) United States
(12) Patent Application Publication
(10) Pub. No.: US 2026/0135487 A1
(43) Pub. Date: May 14, 2026

(54) MULTI-PHASE SWITCHING POWER SUPPLY, AND PHASE NUMBER CONTROL METHOD AND CONTROL CIRCUIT THEREOF

(71) Applicant: Joulwatt Technology Co., Ltd., Hangzhou City (CN)

(72) Inventors: Li SUN, Hangzhou (CN); Rengang CHEN, Hangzhou (CN); Yinxiang LIU, Hangzhou (CN)

(21) Appl. No.: 19/386,348

(22) Filed: Nov. 12, 2025

(30) Foreign Application Priority Data
Nov. 12, 2024 (CN) 202411614461.8

(51) Int. Cl. H02M 3/158

(52) U.S. Cl. CPC H02M 3/1586

(57) ABSTRACT

The present disclosure discloses a multi-phase switching power supply and a phase number control method thereof, and a control circuit. The multi-phase switching power supply comprises n phase power conversion circuits. The phase number control method comprises: controlling operating phase number of the multi-phase switching power supply according to a first parameter and load current; the first parameter comprising at least one of an input voltage, output voltage, and temperature of the multi-phase switching power supply, and the operating phase number refers to the number of power conversion circuits performing power operation. Compared with the existing technology which only controls the operating phase number of the multi-phase switching power supply based on the load current, the present disclosure can make the multi-phase switching power supply operate closer to the actual optimal efficiency curve, and even operate on the actual optimal efficiency curve, thus improving efficiency.

### CROSS-REFERENCE TO RELATED APPLICATIONS

This present disclosure claims priority to a Chinese patent application No. 202411614461.8, filed on November 12, 2024, and entitled "Multi-Phase Switching Power Supply, and Phase Number Control Method and Control Circuit thereof", the entire contents of which are incorporated herein by reference, including the specification, claims, drawings and abstract.

### FIELD OF TECHNOLOGY

The present disclosure relates to the field of power electronics technology, more particularly, to a multi-phase switching power supply and a phase number control method and a control circuit thereof.

### BACKGROUND

The existing multi-phase switching power supply control solution operates at different phase numbers under different load current conditions. Under the same load current condition, the efficiency of multi-phase switching power supply operating at different phase numbers is not the same. In order to ensure the highest efficiency under different load conditions, it needs to adjust the operating phase number to maintain the multi-phase switching power supply operating at the highest efficiency.

The existing phase number control solution for multi-phase switching power supplies only controls the operating phase number based on the load current, that is, the operating phase number of the multi-phase switching power supplies only changes with the change of the load current. The specific solution is to obtain multiple phase adding/shedding

thresholds that can achieve the optimal efficiency curve based on the efficiency curve under different operating phase numbers. The operating phase number of the multi-phase switching power supply is controlled based on the load current sampling signal and multiple phase adding/shedding thresholds. In the existing technical solution, when the input voltage, output voltage, temperature, etc. of the multi-phase switching power supply change, the multiple phase adding/shedding thresholds stay fixed and unchanged. In fact, the optimal efficiency curve obtained by the existing technology is not the true optimal efficiency curve, the phase adding/shedding threshold obtained by the existing technology is not the true optimal efficiency phase adding/shedding threshold too. The true optimal efficiency curve is not only related to the load current, but also to the input voltage, output voltage, temperature, and other factors. The existing solutions cannot take into account these conditions, which causes the system be unable to work on the true optimal efficiency curve, nor reach the highest efficiency.

### SUMMARY OF THE DISCLOSURE

In view of this, the purpose of the present disclosure is to provide a multi-phase switching power supply, and phase number control method and control circuit thereof, to solve the technical problems in the prior art that multi-phase switching power supplies cannot work on the real optimal efficiency curve and cannot achieve the highest efficiency.

The technical solution of the present disclosure is, in the first aspect, providing a phase number control method of a multi-phase switching power supply, comprising n phase power conversion circuits, n being an integer greater than or equal to 2, wherein the phase number control method comprises: controlling the operating phase number of the multi-phase switching power supply based on a first parameter and load current;

the first parameter comprises at least one of the input voltage, output voltage, and temperature of the multi-phase switching power supply, and the operating phase number refers to the number of power conversion circuits performing power operation.

Optionally, the phase number control method further comprises: obtaining a phase adding/shedding threshold of each adjacent operating phase number corresponding to the first parameter sampling signal value based on the first parameter sampling signal representing the first parameter; controlling the operating phase number of the multi-phase switching power supply based on a load current sampling signal representing the load current and the phase adding/shedding threshold of each adjacent operating phase number corresponding to the first parameter sampling signal value.

Optionally, the phase number control method further comprises: obtaining the phase adding/shedding threshold of each adjacent operating phase number corresponding to the first parameter sampling signal value based on the first parameter sampling signal and the optimal phase adding/shedding load current information of adjacent operating phase number under different values of the first parameter; wherein, the optimal phase adding/shedding load current information is the load current information corresponding to intersection points of the efficiency curve of adjacent operating phase number with the same value of the first parameter.

Optionally, the phase number control method further comprises: storing data in the first register based on the optimal phase adding/shedding load current information of adjacent operating phase number under different values of the first parameter; obtaining a table lookup instruction based on the first parameter sampling signal, and reading data from the first register according to the table lookup instruction to obtain the phase adding/shedding threshold of each adjacent operating phase number corresponding to the first parameter sampling signal value.

Optionally, fitting is performed based on the optimal phase adding/shedding load current information of adjacent operating phase number under different values of the first parameter to obtain the fitting formula corresponding to each adjacent operating phase number, the phase adding/shedding load current or phase adding/shedding threshold of each adjacent operating phase number under different values of the first parameter is obtained based on the fitting formula corresponding to each adjacent operating phase number, and storing data in the first register based on the phase adding/shedding load current or phase adding/shedding threshold of each adjacent operating phase number under different values of the first parameter. wherein an independent variable of the fitting formula can represent the information of the first parameter or the sampling signal of the first parameter, and a dependent variable can represent the information of the phase adding/shedding load current or phase adding/shedding threshold of adjacent operating phase number;

Optionally, fitting is performed based on the optimal phase adding/shedding load current information of adjacent operating phase number under different values of the first parameter to obtain the fitting formula corresponding to each adjacent operating phase number, wherein the independent variable of the fitting formula can represent the information of the first parameter or the first parameter sampling signal, and the dependent variable can represent the information of the phase adding/shedding load current of adjacent operating phase number or phase adding/shedding threshold of adjacent operating phase number; according to the first parameter sampling signal and the fitting formula corresponding to each adjacent operating phase number, the phase adding/shedding threshold of each adjacent operating phase number corresponding to the first parameter sampling signal value is obtianed by calculation.

Optionally, according to the first parameter sampling signal, the fitting formula corresponding to each adjacent operating phase number, the optimal phase adding/shedding load current information of adjacent operating phase number when the first parameter or the first parameter sampling signal is equal to a specific value, and the specific value, the phase adding/shedding threshold of each adjacent operating phase number corresponding to the first parameter sampling signal value is obtained by calculation.

Optionally, linear fitting is performed based on the optimal phase adding/shedding load current information of adjacent operating phase number under the different values of the first parameter of to obtain the fitting formula corresponding to each adjacent operating phase number.

Optionally, the phase number control method further comprises: comparing the load current sampling signal with the phase adding/shedding threshold of each adjacent operating phase number corresponding to the first parameter sampling signal value, and controlling the operating phase number of the multi-phase switching power supply according to the comparison result.

Optionally, the first battery pack supplies the multi-phase switching power supply with input voltage, and the first parameter comprises the input voltage.

In the second aspect, the present disclosure further provides a control circuit for a multi-phase switching power supply, the multi-phase switching power supply comprising n phase power conversion circuits, wherein n is an integer greater than or equal to 2, wherein the control circuit controls the operating phase number of the multi-phase switching power supply based on a first parameter and load current; wherein, the first parameter comprises at least one of the input voltage, output voltage, and temperature of the multi-phase switching power supply, and the operating phase number refers to the number of power conversion circuits performing power operation.

### Optionally, the control circuit comprises:

a phase adding/shedding threshold generation unit, outputting the phase adding/shedding threshold of each adjacent operating phase number corresponding to the first parameter sampling signal value based on a first parameter sampling signal representing the first parameter, a phase number control signal generation unit, receiving a load current sampling signal representing the load current, and receiving phase adding/shedding threshold of each the control circuit controls the operating phase number of the multi-phase switching power supply based on the phase number control signal. adjacent operating phase number corresponding to the first parameter sampling signal value output by the phase adding/shedding threshold generation unit, and outputting phase number control signal based on the load current sampling signal and the phase adding/shedding threshold of each adjacent operating phase number corresponding to the first parameter sampling signal value;

Optionally, the phase adding/shedding threshold generation unit obtains the phase adding/shedding threshold of each adjacent operating phase number corresponding to the first parameter sampling signal value based on the first parameter sampling signal and the optimal phase adding/shedding load current information of adjacent operating phase number under different values of the first parameter;

wherein, the optimal phase adding/shedding load current information is the load current information corresponding to intersection points of the efficiency curves of adjacent operating phase number with the same value of the first parameter.

Optionally, the phase adding/shedding threshold generation unit comprises an instruction generation unit and a first register, the instruction generation unit receives the first parameter sampling signal and generates a table lookup instruction based on the first parameter sampling signal value; the phase adding/shedding threshold generation unit reads data from the first register according to the table lookup instruction to obtain the phase adding/shedding threshold of each adjacent operating phase number corresponding to the first parameter sampling signal value; wherein, the data stored in the first register is the data obtained based on the optimal phase adding/shedding load current information of adjacent operating phase number under different values of the first parameter.

Optionally, the phase adding/shedding threshold generation unit comprises a first calculation unit, the first calculation unit receives the first parameter sampling signal and performs calculation according to the first parameter sampling signal and the fitting formula corresponding to each adjacent operating phase number, to output the phase adding/shedding threshold of each adjacent operating phase number corresponding to the first parameter sampling signal value; wherein, the fitting formula corresponding to each adjacent operating phase number is obtained by fitting based on the optimal phase adding/shedding load current information of adjacent operating phase number under different values of the first parameter; the independent variable of the fitting formula can represent the information of the first parameter or the first parameter sampling signal, and the dependent variable can represent the information of the phase adding/shedding load current of adjacent operating phase number or the phase adding/shedding threshold of adjacent operating phase number.

Optionally, the phase adding/shedding threshold generation unit further comprises a second register, the first calculation unit reads data from the second register to obtain the fitting parameters of the fitting formula corresponding to each adjacent operating phase number; and/or, the optimal phase adding/shedding load current information of adjacent operating phase number when the first parameter or the first parameter sampling signal is equal to a specific value.

In the third aspect, the present disclosure further provides a multi-phase switching power supply, comprising n phase power conversion circuits, wherein it comprises the control circuit, or uses the phase number control method to control the operating phase number of the multi-phase switching power supply.

The solution of the present disclosure has the following advantages: compared with the prior art which controls the operating phase number of the multi-phase switching power supply merely according to load current, the present disclosure controls the operating phase number of the multi-phase switching power supply based on the first parameter and load current, which can make the multi-phase switching power supply work closer to the real optimal efficiency curve, and even work on the real optimal efficiency curve, thus further improving efficiency compared with the prior art.

### BRIEF DESCRIPTION OF THE DRAWINGS

FIG. 1 is a flowchart of a phase number control method for a multi-phase switching power supply according to an embodiment of the present disclosure;

FIG. 2 is a flowchart of a method for obtaining the phase adding/shedding threshold of each adjacent operating phase number corresponding to the first parameter sampling signal value in an embodiment of the present disclosure;

FIG. 3 is a flowchart of obtaining the phase adding/shedding threshold of each adjacent operating phase number corresponding to the first parameter sampling signal value in another embodiment of the present disclosure;

FIG. 4 is a schematic diagram of the efficiency curve of a multi-phase switching power supply according to an embodiment of the present disclosure;

FIG. 5A is a schematic diagram of the fitting curve according to an embodiment of FIG. 4;

FIG. 5B is a schematic diagram of the fitting curve according to another embodiment of FIG. 4

FIG. 6 is a schematic diagram of the circuit structure of the multi-phase switching power supply of an embodiment of the present disclosure;

FIG. 7 is a schematic diagram of the circuit structure of the first embodiment of the phase adding/shedding threshold generation unit according to FIG. 6;

FIG. 8 is a schematic diagram of the circuit structure of the second embodiment of the phase adding/shedding threshold generation unit according to FIG. 6;

FIG. 9 is a schematic diagram of the circuit structure of the third embodiment of the phase adding/shedding threshold generation unit according to FIG. 6.

### DETAILED DESCRIPTION OF THE DISCLOSURE

The following will describe the preferred embodiments of the present disclosure in great details by combining with the accompanying drawings. However, the present disclosure is not restricted to these embodiments. The present disclosure convers any replacement, modifications, equivalent methods, and solutions made within the sprits and scope of the present disclosure.

In order to make the public have a thorough understanding, specific details are described in the following preferred embodiments of the present disclosure; however, those skilled in the art can totally understand the present disclosure without these detailed descriptions.

The present disclosure is described in great details in the following paragraphs by referring to the accompanying drawings. It should be noted that the accompanying drawings all use simplified forms and use non-accurate sales, just for the purpose of conveniently and clearly illustrate the embodiments of the present disclosure.

FIG. 1 shows a flowchart of a phase number control method of a multi-phase switching power supply according to an embodiment of the present disclosure. The multi-phase switching power supply comprises n phase power conversion circuits, where n is an integer greater than or equal to 2. The phase number control method of this embodiment comprises controlling the operating phase number of the multi-phase switching power supply based on a first parameter and load current; the first parameter comprises at least one of the input voltage, output voltage, and temperature of the multi-phase switching power supply, and the operating phase number refers to the number of power conversion circuits performing power operation. Specifically, the phase number control method of this embodiment may comprise:

In step S100, the phase adding/shedding threshold of each adjacent operating phase number corresponding to the first parameter sampling signal value is obtained based on a first parameter sampling signal representing the first parameter.

In some embodiments, the phase adding/shedding threshold of each adjacent operating phase number corresponding to the first parameter sampling signal value (or corresponding to the first parameter value) can be obtained based on the first parameter sampling signal and the optimal phase adding/shedding load current information of adjacent operating phase number under different values of the first parameter; wherein, the optimal phase adding/shedding load current information is the load current information corresponding to the intersection points of the efficiency curves of adjacent operating phase number with the same value of the first parameter. The optimal phase adding/shedding load current information of adjacent operating phase number under different values of the first parameter represents the optimal phase adding/shedding load current information of adjacent operating phase number when the first parameter is equal to two or more different values. Schematically, the optimal phase adding/shedding load current information comprises the optimal phase adding/shedding load current or the optimal phase adding/shedding threshold, and the optimal phase adding/shedding load current is equal to the corresponding load current of the intersection point, and the optimal phase adding/shedding threshold is equal to the corresponding load current sampling signal of the intersection point. Refer to FIG. 4 for details, which takes the first parameter as the input voltage Vin of the multi-phase switching power supply as an example, showing the efficiency curves when the input voltage Vin is equal to V1, V2, and V3 respectively, and the operating phase number is equal to 1-phase, 2-phase, 3-phase, and 4-phase respectively; the vertical axis of the efficiency curve is efficiency, and the horizontal axis can be selected from load current io or load current sampling signal Sio. Wherein, I_{12_1}, I_{23_1}, and I_{34_1} represent the optimal phase adding/shedding load current of 1-phase-2-phase, 2-phase-3-phase, and 3-phase-4-phase respectively when the input voltage Vin=V1; I_{12_2}, I2_{3_2}, and I_{34_2} represent the optimal phase adding/shedding load current of 1-phase-2-phase, 2-phase-3-phase, and 3-phase-4-phase when the input voltage Vin=V2, respectively; I_{12_3}, I_{23_3}, and I_{34_3} represent the optimal phase adding/shedding load current of 1-phase-2-phase, 2-phase-3-phase, and 3-phase-4-phase respectively when the input voltage Vin=V3. Correspondingly, th_{12_1}, th_{23_1}, and th_{34_1} represent the optimal phase adding/shedding threshold of 1-phase-2-phase, 2-phase-3-phase, and 3-phase-4-phase respectively when the input voltage Vin=V1; th_{12_2}, th_{23_2}, and th_{34_2} represent the optimal phase adding/shedding thresholds of 1-phase-2-phase, 2-phase-3-phase, and 3-phase-4-phase respectively when the input voltage Vin=V2; th_{12_3}, th_{23_3}, and th_{34_3} represent the optimal phase adding/shedding threshold of 1-phase-2-phase, 2-phase-3-phase, and 3-phase-4-phase respectively when the input voltage Vin=V3.

In step S200, the operating phase number of the multi-phase switching power supply is controlled based on a load current sampling signal representing the load current and the phase adding/shedding threshold of each adjacent operating phase number corresponding to the first parameter sampling signal value.

In some embodiments, the load current sampling signal can be compared with the phase adding/shedding threshold of each adjacent operating phase number corresponding to the first parameter sampling signal value, and the operating phase number of the multi-phase switching power supply can be controlled based on the comparison result.

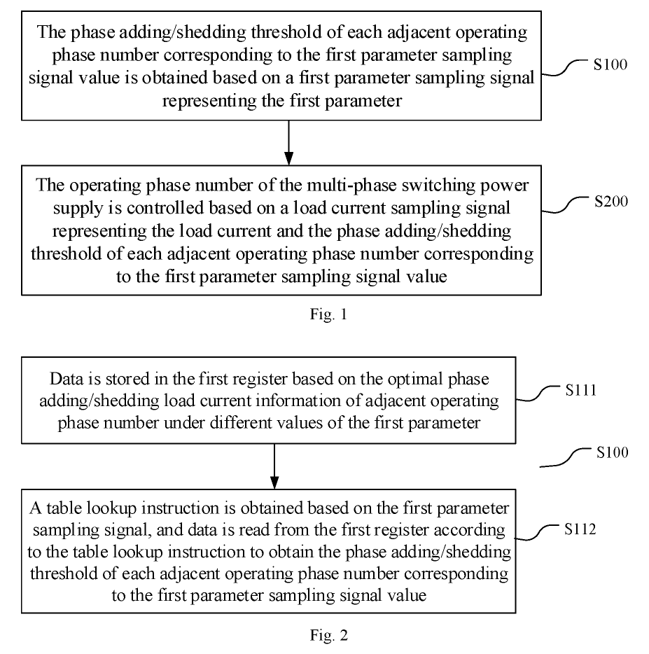

FIG. 2 shows a flowchart of a method for obtaining the phase adding/shedding threshold of each adjacent operating phase number corresponding to the first parameter sampling signal value in an embodiment of the present disclosure. In this embodiment, the phase adding/shedding threshold of each adjacent operating phase number corresponding to the first parameter sampling signal value is obtained by using a lookup table method based on the first parameter sampling signal. Step S100 in FIG. 2 comprises steps S111 and S112, that is, in this embodiment, the method for obtaining the phase adding/shedding threshold of each adjacent operating phase number corresponding to the first parameter sampling signal value comprises:

In step S111, data is stored in the first register based on the optimal phase adding/shedding load current information of adjacent operating phase number under different values of the first parameter;

In step S112, a table lookup instruction is obtained based on the first parameter sampling signal, and data is read from the first register according to the table lookup instruction to obtain the phase adding/shedding threshold of each adjacent operating phase number corresponding to the first parameter sampling signal value;

In some embodiments, in step S111, the optimal phase adding/shedding load current information of adjacent operating phase number under different values of the first parameter can be stored in the first register. Schematically, the optimal phase adding/shedding load currents (I_{12_1}, I_{23_1}, I_{34_1}, I_{12_2}, I_{23_2}, I_{34_2}, I_{12_3}, I_{23_3}, I_{34_3}) or the optimal phase adding/shedding thresholds (th_{12_1}, th_{23_1}, th_{34_1}, th_{12_2}, th_{23_2}, th_{34_}2, th_{12_3}, th_{23_3}, th_{34_3}) shown in FIG. 4 can be stored in the first register; correspondingly, in step S112, a table lookup instruction can be obtained by determining which input voltage value corresponding to the input voltage sampling signal value is closest to V1, V2, or V3. For example, if the input voltage value corresponding to the input voltage sampling signal value is closest to V1, then I_{12_1}, I_{23_1}, I_{34_1} or th_{12_1}, th_{23_1}, th_{34_1} can be read from the first register to obtain the phase adding/shedding threshold of each adjacent operating phase number corresponding to the first parameter sampling signal value.

During efficiency test, it is sufficient to test the efficiency curves under two or more different values of the first parameter. For example, in FIG. 4, the efficiency under three different input voltages (V1, V2, V3) is tested. In order to store more phase adding/shedding load currents or phase adding/shedding thresholds under different values of the first parameter in the first register without increasing the cost of efficiency test, for the multi-phase switching power supply is closer to the real optimal efficiency curve, in some other embodiments, in step S111, fitting can also be performed based on the optimal phase adding/shedding load current

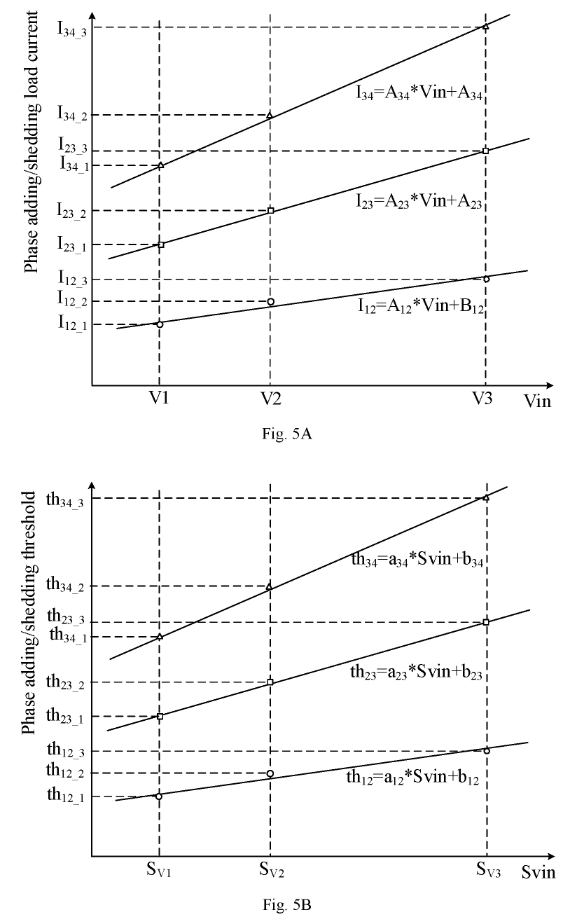

information of adjacent operating phase number under different values of the first parameter to obtain fitting formulas corresponding to each adjacent operating phase number. The independent variable of the fitting formula can represent the information of the first parameter or the sampling signal of the first parameter, and the dependent variable can represent the information of the phase adding/shedding load current of adjacent operating phase number or the phase adding/shedding threshold of adjacent operating phase number; the phase adding/shedding load current or phase adding/shedding threshold of each adjacent operating phase number under different values of the first parameter is obtained based on the fitting formula corresponding to each adjacent operating phase number, and data is stored in the first register based on the phase adding/shedding load current or phase adding/shedding threshold of each adjacent operating phase number under different values of the first parameter. Wherein, the phase adding/shedding load current represents the corresponding load current when the load current sampling signal is equal to the phase adding/shedding threshold. In some embodiments, the independent variable of the fitting formula comprises a first parameter or a first parameter sampling signal, and the dependent variable of the fitting formula comprises the phase adding/shedding load current of adjacent operating phase number or the phase adding/shedding threshold of adjacent operating phase number. Specific reference can be made to FIGS. 5A and 5B, both of which are schematic diagrams of the fitting curves obtained based on FIG. 4 and are illustrated by linear fitting; wherein, the independent variable of each fitting formula in FIG. 5A is the input voltage Vin, and the dependent variables are the phase adding/shedding load currents I12, I23, and I34 of each adjacent operating phase number. The independent variable of each fitting formula in FIG. 5B is the input voltage sampling signal Svin, and the dependent variables are the phase adding/shedding threshold th12, th23, and th34 of each adjacent operating phase number. Of course, in other embodiments, the independent variable of the fitting formula can also be set as the input voltage, the dependent variable is the phase adding/shedding threshold of the adjacent operating phase number, or the independent variable is the input voltage sampling signal, and the dependent variable is the phase adding/shedding load current of the adjacent operating phase number. Take the fitting formulas shown in FIG. 5A as an example, substitute the input voltage Vin=V4 into each fitting formula (I12=A12*in+B12, I23=A23*Vin+B23, I34=A34*Vin+B34), wherein V4 is not equal to V1, V2, and V3. This will obtain the phase adding/shedding load current of each adjacent operating phase number corresponding to the input voltage Vin=V4, and also store it in the first register. Therefore, without increasing the cost of efficiency test, more phase adding/shedding load currents under different values of the first parameter can be stored in the first register.

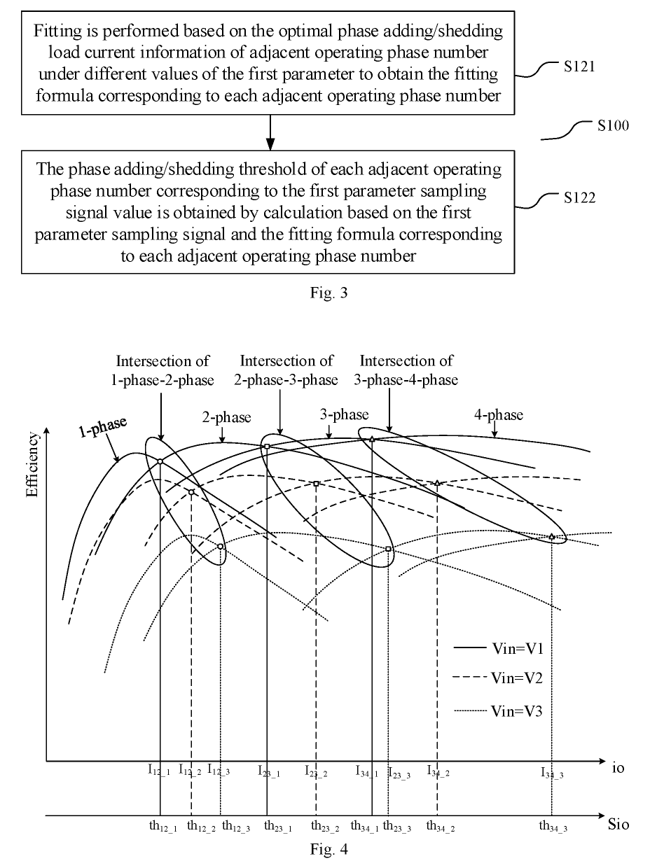

FIG. 3 is a flowchart of a method for obtaining the phase adding/shedding threshold of each adjacent operating phase number corresponding to the first parameter sampling signal value of another embodiment of the present disclosure; in this embodiment, the phase adding/shedding threshold of each adjacent operating phase number corresponding to the first parameter sampling signal value are obtained through calculation based on the first parameter sampling signal and the optimal phase adding/shedding load current information of adjacent operating phase number under different values of the first parameter. In FIG. 3, step S100 comprises steps S121 and S122. That is to say, in this embodiment, the method for obtaining the phase adding/shedding threshold of each adjacent operating phase number corresponding to the first parameter sampling signal value comprises:

In step S121, fitting is performed based on the optimal phase adding/shedding load current information of adjacent operating phase number under different values of the first parameter to obtain the fitting formula corresponding to each adjacent operating phase number; wherein the independent variable of the fitting formula can represent the information of the first parameter or the sampling signal of the first parameter, and the dependent variable can represent the information of the phase adding/shedding load current of adjacent operating phase number or the phase adding/shedding threshold of adjacent operating phase number.

As for the fitting formula, refer to FIGS. 5A and 5B and the previous introduction, which will not be repeated here.

In step S122, the phase adding/shedding threshold of each adjacent operating phase number corresponding to the first parameter sampling signal value is obtained by calculation based on the first parameter sampling signal and the fitting formula corresponding to each adjacent operating phase number.

In some embodiments, the first parameter sampling signal can be substituted into the fitting formula corresponding to each adjacent operating phase number to obtain the phase adding/shedding threshold of each adjacent operating phase number corresponding to the first parameter sampling signal value. Schematically, when the independent variable of the fitting formula is the first parameter sampling signal, the first parameter sampling signal can be directly substituted into the fitting formula; when the independent variable of the fitting formula is the first parameter, the quotient of the first parameter sampling signal and the first parameter sampling coefficient can be substituted into the fitting formula, wherein the first parameter sampling coefficient is the proportionality coefficient between the first parameter sampling signal and the first parameter; when the dependent variable of the fitting formula is the phase adding/shedding threshold of adjacent operating phase number, the first parameter sampling signal can be substituted into the fitting formula for calculation, and use the calculation result directly as the phase adding/shedding threshold of adjacent operating phase number; when the dependent variable of the fitting formula is the phase adding/shedding load current of adjacent operating phase number, the first parameter sampling signal can be substituted into the fitting formula for calculation, and use the product of the calculated result and the load current sampling coefficient as the phase adding/shedding threshold of the adjacent operating phase number, where the load current sampling coefficient is the proportional coefficient between the load current sampling signal and the load current.

In some other embodiments, the phase adding/shedding threshold of each adjacent operating phase number corresponding to the first parameter sampling signal value can also be calculated based on the first parameter sampling signal, the fitting formula corresponding to each adjacent operating phase number, the optimal phase adding/shedding load current information of adjacent operating phase number when the first parameter or the first parameter sampling signal is equal to a specific value, and the specific value. In an embodiment, take the fitting formula corresponding to the fitting curve shown in FIG. 5B as an example, the phase adding/shedding threshold of each adjacent operating phase number corresponding to the first parameter sampling signal value can be calculated based on the input voltage sampling signal Svin, the fitting formulas corresponding to each adjacent operating phase number (th₁₂=a₁₂*Svin+b₁₂, th₂₃=a₂₃*Svin+b₂₃, th₃₄=a₃₄*Svin+b₄₄), the optimal phase adding/shedding threshold of each adjacent operating phase number when the input voltage sampling signal Svin is equal to a specific value (such as S_{V2}), and the specific value S_{V2}. Schematically, when calculation is performed according to the optimal phase adding/shedding threshold th_{12_2} between 1-phase and 2-phase when the input voltage sampling signal Svin is equal to a specific value (e.g. S_{V2}), the phase adding/shedding threshold between 1-phase and 2-phase corresponding to the first parameter sampling signal value is obtained by calculating the value of th_{12_2}+a₁₂*(Svin-S_{V2}); when calculation is performed according to the optimal phase adding/shedding threshold th_{23_2} between 2-phase and 3-phase when the input voltage sampling signal Svin is equal to S_{V2}, the phase adding/shedding threshold between 2-phase and 3-phase corresponding to the first parameter sampling signal value is obtained by calculating the value of th_{23_2}+a₂₃*(Svin-S_{V2}).

To sum up, compared with the existing technology, by using the phase number control method provided by the embodiments of the disclosure, the phase adding/shedding threshold changes with the first parameter sampling signal (or, change with the first parameter). The operating phase number of the multi-phase switching power supply is not only controlled by the load current, but also by the first parameter, which can make the phase adding/shedding threshold closer to the optimal phase adding/shedding threshold, even equal to the optimal phase adding/shedding threshold, so as to make the multi-phase switching power supply work closer to the real optimal efficiency curve, and even work on the real optimal efficiency curve, further improving the efficiency of the multi-phase switching power supply.

In an embodiment, the first battery pack provides input voltage to the multi-phase switching power supply, wherein the first battery pack comprises one or more batteries, and the input voltage provided by the first battery pack varies with usage and battery capacity. The first parameter is set to include the input voltage of the multi-phase switching power supply, and the phase adding/shedding threshold varies with the input voltage, which can improve the efficiency of the multi-phase switching power supply and save battery losses.

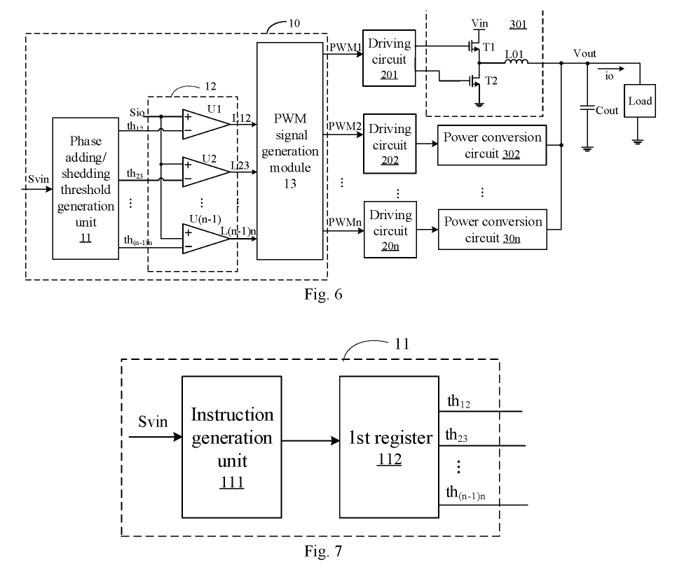

Refer to FIG. 6, the embodiment of the present disclosure provides a multi-phase switching power supply that receives an input voltage Vin and provides an output voltage Vout and a load current io to the load. The multi-phase switching power supply comprises n phase power conversion circuits 301~30n, a control circuit 10, and an output capacitor Cout, wherein n is an integer greater than or equal to 2. The n-phase power conversion circuit 301~30n is connected in parallel between the input voltage Vin of the multi-phase switching power supply and the load. The control circuit 10 controls the operating phase number of the multi-phase switching power supply according to the first parameter and the load current; wherein, the first parameter comprises at least one of the input voltage Vin, output voltage Vout, and temperature of the multi-phase switching power supply, and the operating phase number refers to the number of power conversion circuits performing power operation. This application does not limit the topology type of power conversion circuits 301~30n. FIG. 6 only takes a buck topology an example, showing the specific circuit structure of power conversion circuit 301, comprising a first switch transistor T1 and a second switch transistor T2 connected between the input voltage Vin and the ground, as well as an inductor L01 connected between the common terminal of first switch device T1 and second switch device T2 and the output terminal of multi-phase switching power supply.

FIG. 6 shows a schematic diagram of the circuit structure of a multi-phase switching power supply according to an embodiment of the present disclosure. FIG. 6 takes the first parameter being the input voltage Vin of the multi-phase switching power supply as an example. In the embodiment shown in FIG. 6, the control circuit 10 controls the operating phase number of the multi-phase switching power supply according to the input voltage Vin and load current io. Specifically, the control circuit 10 controls the operating phase number of the multi-phase switching power supply based on the input voltage sampling signal Svin representing the input voltage Vin and the load current sampling signal Sio representing the load current io; the control circuit 10 comprises a phase adding/shedding threshold generation unit 11 and a phase control signal generation unit 12. The phase adding/shedding threshold generation unit 11 outputs phase adding/shedding threshold th₁₂, th₂₃... th₍ₙ₋₁₎ₙ of each adjacent operating phase number corresponding to the input voltage sampling signal value (or called corresponding to the input voltage value) according to the input voltage sampling signal Svin; the phase control signal generation unit 12 receives the load current sampling signal Sio, and receives the phase adding/shedding threshold of each adjacent operating phase number corresponding to the input voltage sampling signal value output by the phase adding/shedding threshold generation unit 11, and outputs the phase control signal based on the load current sampling signal and the phase adding/shedding threshold of each adjacent operating phase number corresponding to the input voltage sampling signal value; the control circuit 10 controls the operating phase number of the multi-phase switching power supply according to the phase control signal. In addition, the control circuit 10 also comprises a PWM signal generation module 13, n driving circuits 201-20n, an input voltage sampling circuit (not shown in the drawing), and a load current sampling circuit (not shown in the drawing). Wherein, the input voltage sampling circuit is used to generate the input voltage sampling signal Svin. The load current sampling circuit is used to generate the load current sampling signal Sio. The PWM signal generation module 13 is used to generate n-phase PWM signals PWM1~PWMn. Each driving circuit receives a PWM signal and controls the on and off of the corresponding switching transistor in the power conversion circuit based on the received PWM signal. In one embodiment, as shown in FIG. 6, the PWM signal generation module 13 receives the phase number control signal and controls whether the PWM signals PWM1~PWMn are in a high resistance state according to the phase number control signal, in order to control whether each power conversion circuit works (i.e. whether each power conversion circuit performing power operation). When the PWM signal is in a high resistance state, it controls the power conversion circuit of the corresponding phase not to work, and when the PWM signal is in a non-high resistance state, it controls the power conversion circuit of the corresponding phase to work. In another embodiment, it is also possible to set the PWM signal generation module 13 to not receive the phase number control signal, but to control whether each driving circuit 201-20n is enabled (not shown in the drawing) based on the phase number control signal, so as to control whether the power conversion circuit of the corresponding phase works. In an embodiment, the phase number control signal generation unit 12 can compare the load current sampling signal with the phase adding/shedding threshold of each adjacent operating phase number corresponding to the input voltage sampling signal value, and output the phase control signal based on the comparison result. Schematically, the phase number control signal generation unit 12 comprises comparators U0~U(n-1). The first input terminals of comparators U0~U(n-1) all receive load current sampling signals, and the second input terminals respectively receive phase adding/shedding threshold th12, th23... th(n-1)n of each adjacent operating phase number corresponding to the input voltage sampling signal value. The output terminals respectively output comparison signals L12, L23... L(n-1)n, and use each comparison signal as the phase control signal.

FIG. 7 shows a schematic diagram of the circuit structure of the first embodiment of the phase adding/shedding threshold generation unit according to FIG. 6. In this embodiment, the phase adding/shedding threshold generation unit 11 comprises an instruction generation unit 111 and a first register 112. The instruction generation unit receives the input voltage sampling signal Svin and generates a table lookup instruction based on the value of the input voltage sampling signal; the phase adding/shedding threshold generation unit 11 reads data from the first register 112 according to the table lookup instruction to obtain the phase adding/shedding threshold th₁₂, th₂₃... th₍ₙ₋₁₎ₙ of each adjacent operating phase number corresponding to the input voltage sampling signal value, where th₁₂ represents the phase adding/shedding threshold between 1-phase and 2-phase, th₂₃ represents the phase adding/shedding threshold between 2-phase and 3-phase, and th₍ₙ₋₁₎ₙ represents the phase adding/shedding threshold between (n-1) -phase and n-phase; wherein, the data stored in the first register 112 is the data obtained based on the optimal phase adding/shedding load current information of adjacent operating phase number under different input voltages. Schematically, when the data stored in the first register 112 is the optimal phase adding/shedding threshold, the optimal phase adding/shedding threshold of the adjacent operating phase number corresponding to the input voltage sampling signal value can be read from the first register 112 and used as the phase adding/shedding threshold of the adjacent operating phase number corresponding to the input voltage sampling signal value for output. When the data stored in the first register 112 is the optimal phase adding/shedding load current, the phase adding/shedding threshold generation unit 11 also comprises a signal processing unit (not shown in the drawing), which processes the optimal phase adding/shedding load current of the adjacent operating phase number corresponding to the input voltage sampling signal value read from the first register 112 to output the phase adding/shedding threshold of the adjacent operating phase number corresponding to the input voltage sampling signal value.

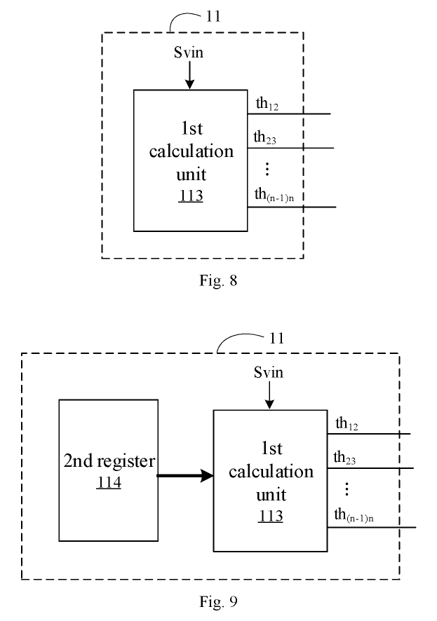

FIG. 8 shows a schematic diagram of the circuit structure of the second embodiment of the phase adding/shedding threshold generation unit according to FIG. 6. In this embodiment, the phase adding/shedding threshold generation unit 11 comprises a first calculation unit 113. The first calculation unit 113 receives the input voltage sampling signal Svin and calculates the phase adding/shedding threshold of each adjacent operating phase number corresponding to the input voltage sampling signal value based on the input voltage sampling signal Svin and the fitting formula corresponding to adjacent operating phase number; wherein, the fitting formula corresponding to adjacent operating phase number is obtained by fitting based on the optimal phase adding/shedding load current information of adjacent operating phase number under different input voltages. The independent variable of the fitting formula can represent the information of the input voltage or input voltage sampling signal, and the dependent variable can represent the information of the phase adding/shedding load current of adjacent operating phase number or the phase adding/shedding threshold of adjacent operating phase number. In some embodiments, the first calculation unit 113 may substitute the input voltage sampling signal into the fitting formula corresponding to each adjacent operating phase number to output the phase adding/shedding threshold of each adjacent operating phase number corresponding to the input voltage sampling signal value. In other embodiments, the first calculation unit 113 may also calculate the phase adding/shedding threshold of each adjacent operating phase number corresponding to the input voltage sampling signal value based on the input voltage sampling signal, the fitting formula corresponding to each adjacent operating phase number, the optimal phase adding/shedding load current information of adjacent operating phase number when the input voltage signal or input voltage sampling signal is equal to a specific value, and the specific value.

FIG. 9 shows a schematic diagram of the circuit structure of the third embodiment according to the phase adding/shedding threshold generation unit of FIG. 6. Compared with the phase adding/shedding threshold generation unit shown in FIG. 8, the phase adding/shedding threshold generation unit 11 of this embodiment further comprises a second register 114, and the first calculation unit 113 reads data from the second register 114 to obtain the fitting parameters of the fitting formula corresponding to each adjacent operating phase number; and/or, the optimal phase adding/shedding load current information of adjacent operating phase number when the input voltage signal or the input voltage sampling signal is equal to a specific value. The fitting formula corresponding to the fitting curve shown in FIG. 5B will be introduced as an example. In some embodiments, the fitting parameters a₁₂, b₁₂, a₂₃, b₂₃, a₃₄, and b₃₄ corresponding to the fitting formulas corresponding to each adjacent operating phase number can be stored in the second register 114. The first calculation unit 113 performs calculation based on the input voltage sampling signal Svin and the fitting parameters a₁₂, b₁₂, a₂₃, b₂₃, a₃₄, and b₃₄ read from the second register 114 using the fitting formulas corresponding to each adjacent operating phase number. In some embodiments, the optimal phase adding/shedding threshold for the adjacent operating phase number when the input voltage sampling signal is equal to a specific value can also be stored in the second register 114. The first calculation unit 113 performs calculation based on the input voltage sampling signal Svin, the fitting formula corresponding to each adjacent operating phase number, and the data read from the second register 114; in an embodiment, the specific value can also be stored in the second register 114 simultaneously; in one embodiment, it is also possible to simultaneously store some or all of the fitting parameters of the fitting formula corresponding to each adjacent operating phase number in the second register 114.

It should be noted that for ease of understanding, FIGS. 4 to 9 of the present application are all illustrated with the input voltage Vin of a multi-phase switching power supply as the first parameter. Based on the above introduction, those skilled in the art can easily obtain a solution where the first parameter is the output voltage Vout or temperature of the multi-phase switching power supply, as well as a solution where the first parameter comprises two or three of the input voltage Vin, output voltage Vout, and temperature of the multi-phase switching power supply, which is omitted here.

It should also be noted that this application does not limit the data type of the phase adding/shedding threshold, which can be digital or analog. The present application does not limit the forms of the fitting function used to obtain the fitting formulas of each adjacent operating phase number. In the embodiments shown in FIGS. 5A and 5B, a relatively simple linear fitting is used to obtain the fitting formula in the form of a linear function; non-linear fitting can also be used in other embodiments to obtain fitting formulas in the forms of polynomial functions, exponential functions, logarithmic functions, etc.

To sum up, the embodiments of the present disclosure can control the operating phase number of the multi-phase switching power supply based on the first parameter and load current. Compared with the prior art which only controls the operating phase number of the multi-phase switching power supply based on the load current, it can make the multi-phase switching power supply work closer to the real optimal efficiency curve, and even work on the real optimal efficiency curve, which can further improve the efficiency of the multi-phase switching power supply.

The above implementations do not constitute a limitation on the scope of protection of the technical solution. Any modifications, equivalent replacements, and improvements made within the spirits and principles of the above implementation shall be included within the protection scope of the technical solution.

What is claimed is:

1. A phase number control method of a multi-phase switching power supply, the multi-phase switching power supply comprising n phase power conversion circuits, n being an integer greater than or equal to 2, wherein the phase number control method comprises:
controlling operating phase number of the multi-phase switching power supply based on a first parameter and load current;
wherein the first parameter comprises at least one of an input voltage, an output voltage, and a temperature of the multi-phase switching power supply, and the operating phase number refers to the number of power conversion circuits performing power operation.

2. The phase number control method of claim 1, comprising:
obtaining phase adding/shedding threshold of each adjacent operating phase number corresponding to a first parameter sampling signal value based on a first parameter sampling signal representing the first parameter;
controlling the operating phase number of the multi-phase switching power supply based on a load current sampling signal representing the load current and the phase adding/shedding threshold of each adjacent operating phase number corresponding to the first parameter sampling signal value.

3. The phase number control method of claim 2, wherein,
the phase adding/shedding threshold of each adjacent operating phase number corresponding to the first parameter sampling signal value is obtaiend based on the first parameter sampling signal and optimal phase adding/shedding load current information of adjacent operating phase number under different values of the first parameter;
wherein, the optimal phase adding/shedding load current information is load current information corresponding to intersection points of the efficiency curve of adjacent operating phase number with the same value of the first parameter.

4. The phase number control method of claim 3, wherein,
data in the first register is stored based on the optimal phase adding/shedding load current information of adjacent operating phase number under different values of the first parameter;
a table lookup instruction is obtained based on the first parameter sampling signal, and reading data from the first register according to the table lookup instruction to obtain the phase adding/shedding threshold of each adjacent operating phase number corresponding to the first parameter sampling signal value.

5. The phase number control method of claim 4, wherein,
fitting is performed based on the optimal phase adding/shedding load current information of adjacent operating phase number under different values of the first parameter to obtain a fitting formula corresponding to each adjacent operating phase number, wherein an independent variable of the fitting formula represents the information of the first parameter or the sampling signal of the first parameter, and a dependent variable represents the information of the phase adding/shedding load current or phase adding/shedding threshold of adjacent operating phase number;
the phase adding/shedding load current or phase adding/shedding threshold of each adjacent operating phase number under different values of the first parameter is obtained based on the fitting formula corresponding to each adjacent operating phase number, and storing data in the first register based on the phase adding/shedding load current or phase adding/shedding threshold of each adjacent operating phase number under different values of the first parameter.

6. The phase number control method of claim 5, wherein,
linear fitting is performed based on the optimal phase adding/shedding load current information of adjacent operating phase number under the different values of the first parameter of to obtain the fitting formula corresponding to each adjacent operating phase number.

7. The phase number control method of claim 3, wherein,
fitting is performed based on the optimal phase adding/shedding load current information of adjacent operating phase number under different values of the first parameter to obtain a fitting formula corresponding to each adjacent operating phase number, wherein an independent variable of the fitting formula represents the information of the first parameter or the first parameter sampling signal, and a dependent variable represents the information of the phase adding/shedding load current of adjacent operating phase number or phase adding/shedding threshold of adjacent operating phase number;
according to the first parameter sampling signal and the fitting formula corresponding to each adjacent operating phase number, the phase adding/shedding threshold of each adjacent operating phase number corresponding to the first parameter sampling signal value by calculation is obtained.

8. The phase number control method of claim 7, wherein,
linear fitting is performed based on the optimal phase adding/shedding load current information of adjacent operating phase number under the different values of the first parameter of to obtain the fitting formula corresponding to each adjacent operating phase number.

9. The phase number control method of claim 7, wherein,
according to the first parameter sampling signal, the fitting formula corresponding to each adjacent operating phase number, the optimal phase adding/shedding load current information of adjacent operating phase number upon the first parameter or the first parameter sampling signal being equal to a specific value, and the specific value, the phase adding/shedding threshold of each adjacent operating phase number corresponding to the first parameter sampling signal value by calculation is obtained.

10. The phase number control method of claim 9, wherein,
linear fitting is performed based on the optimal phase adding/shedding load current information of adjacent operating phase number under the different values of the first parameter of to obtain the fitting formula corresponding to each adjacent operating phase number.

11. The phase number control method of claim 2, wherein,
the load current sampling signal is compared with the phase adding/shedding threshold of each adjacent operating phase number corresponding to the first parameter sampling signal value, and controlling the operating phase number of the multi-phase switching power supply according to a comparison result.

12. The phase number control method of claim 1, wherein the first battery pack supplies the multi-phase switching power supply with the input voltage, and the first parameter comprises the input voltage.

13. A control circuit for a multi-phase switching power supply, the multi-phase switching power supply comprising n phase power conversion circuits, wherein n is an integer greater than or equal to 2, wherein,
the control circuit controls operating phase number of the multi-phase switching power supply based on a first parameter and load current;
wherein, the first parameter comprises at least one of an input voltage, an output voltage, and a temperature of the multi-phase switching power supply, and the operating phase number refers to the number of power conversion circuits performing power operation.

14. The control circuit of claim 13, wherein the control circuit comprises:
a phase adding/shedding threshold generation unit, outputting phase adding/shedding threshold of each adjacent operating phase number corresponding to the first parameter sampling signal value based on a first parameter sampling signal representing the first parameter,
a phase number control signal generation unit, receiving a load current sampling signal representing the load current, and receiving phase adding/shedding threshold of each adjacent operating phase number corresponding to the first parameter sampling signal value output by the phase adding/shedding threshold generation unit, and outputting phase number control signal based on the load current sampling signal and the phase adding/shedding threshold of each adjacent operating phase number corresponding to the first parameter sampling signal value;
wherein the control circuit controls the operating phase number of the multi-phase switching power supply based on the phase number control signal.

15. The control circuit of claim 14, wherein the phase adding/shedding threshold generation unit obtains the phase adding/shedding threshold of each adjacent operating phase number corresponding to the first parameter sampling signal value based on the first parameter sampling signal and optimal phase adding/shedding load current information of adjacent operating phase number under different values of the first parameter;
wherein, the optimal phase adding/shedding load current information is the load current information corresponding to intersection points of the efficiency curves of adjacent operating phase number with the same value of the first parameter.

16. The control circuit of claim 15, wherein the phase adding/shedding threshold generation unit comprises an instruction generation unit and a first register,
the instruction generation unit receives the first parameter sampling signal and generates a table lookup instruction based on the first parameter sampling signal value;
the phase adding/shedding threshold generation unit reads data from the first register according to the table lookup instruction to obtain the phase adding/shedding threshold of each adjacent operating phase number corresponding to the first parameter sampling signal value;
wherein, the data stored in the first register is the data obtained based on the optimal phase adding/shedding load current information of adjacent operating phase number under different values of the first parameter.

17. The control circuit of claim 15, wherein the phase adding/shedding threshold generation unit comprises a first calculation unit,
the first calculation unit receives the first parameter sampling signal and performs calculation according to the first parameter sampling signal and the fitting formula corresponding to each adjacent operating phase number, to output the phase adding/shedding threshold of each adjacent operating phase number corresponding to the first parameter sampling signal value;
wherein, the fitting formula corresponding to each adjacent operating phase number is obtained by fitting based on the optimal phase adding/shedding load current information of adjacent operating phase number under different values of the first parameter; the independent variable of the fitting formula can represent the information of the first parameter or the first parameter sampling signal, and the dependent variable can represent the information of the phase adding/shedding load current of adjacent operating phase number or the phase adding/shedding threshold of adjacent operating phase number.

18. The control circuit of claim 17, wherein the phase adding/shedding threshold generation unit further comprises a second register,
the first calculation unit reads data from the second register to obtain the fitting parameters of the fitting formula corresponding to each adjacent operating phase number; and/or,
the optimal phase adding/shedding load current information of adjacent operating phase number upon the first parameter or the first parameter sampling signal being equal to a specific value.

19. A multi-phase switching power supply, comprising n phase power conversion circuits, wherein the multi-phase switching power supply comprises the control circuit of claim 13.
